(19) United States
(12) Patent Application Publication
(10) Pub. No.: US 2023/0299881 A1
(43) Pub. Date: Sep. 21, 2023

(54) ACCESS POINT, STATION, AND WIRELESS COMMUNICATION METHOD

(71) Applicant: GUANGDONG OPPO MOBILE TELECOMMUNICATIONS CORP., LTD., DONGGUAN (CN)

(72) Inventor: Lei HUANG, Singapore (SG)

(21) Appl. No.: 18/200,725

(22) Filed: May 23, 2023

Related U.S. Application Data
(63) Continuation of application No. PCT/CN2020/135827, filed on Dec. 11, 2020.

(51) Int. Cl. H04L 1/00

(52) U.S. Cl. CPC H04L 1/0068; H04W 84/12

(57) ABSTRACT

An access point (AP), a station (STA), and a wireless communication method are provided. The wireless communication method includes configuring, by an AP, an aggregated physical layer protocol data unit (A-PPDU) comprising one or more high efficiency (HE) PPDUs and/or one or more extremely high throughput (EHT) PPDUs, and determining if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU. This can solve issues in the prior art, apply an appropriate spectral mask to the A-PPDU, reduce adjacent-channel interference, achieve extremely high throughput, provide good communication performance, and/or provide high reliability.

### CROSS-REFERENCE TO RELATED APPLICATION

This is a continuation of International Application No. PCT/CN2020/135827 filed on Dec. 11, 2020, the entire contents of which are incorporated herein by reference in its entirety.

### TECHNICAL FIELD

The present disclosure relates to the field of communication systems, and more particularly, to an access point (AP), a station (STA), and a wireless communication method, which can provide a good communication performance and/or provide high reliability.

### BACKGROUND

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as, time, frequency, and power). A wireless network, for example a wireless local area network (WLAN), such as a Wi-Fi (institute of electrical and electronics engineers (IEEE) 802.11) network may include an access point (AP) that may communicate with one or more stations (STAs) or mobile devices. The WLAN enables a user to wirelessly access an internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, a STA may communicate with an associated AP via downlink and uplink. The downlink may refer to a communication link from the AP to the STA, and the uplink may refer to a communication link from the STA to the AP.

In recent times, to support increased numbers of devices supporting WLAN, such as smartphones, more APs have been deployed. Despite increase in use of WLAN devices supporting the IEEE 802.11ax high efficiency (HE) WLAN standard, that provide high performance relative to WLAN devices supporting the legacy IEEE 802.11g/n/ac standard, a WLAN system supporting higher performance is required due to WLAN users' increased use of high volume content such as a ultra-high definition video. Although a conventional WLAN system has aimed at increase of bandwidth and improvement of a peak transmission rate, actual users thereof could not feel drastic increase of such performance.

In a task group called IEEE 802.11be, extremely high throughput (EHT) WLAN standardization is under discussion. The EHT WLAN aims at achieving extremely high throughput (EHT) and/or improving performance felt by users demanding high-capacity, high-rate services while supporting simultaneous access of numerous stations in an environment in which a plurality of APs is densely deployed and coverage areas of APs overlap.

IEEE 802.11be EHT WLAN supports a bandwidth (BW) up to 320 MHz. It is expected that high efficiency (HE) STAs will exist with EHT STAs in a same EHT basic service set (BSS). In order to maximize throughput of an EHT BSS with large BW (e.g. 320 MHz), an aggregated physical layer (PHY) protocol data unit (A-PPDU) has been proposed.

In IEEE 802.11ax HE WLAN, in order to reduce adjacent-channel interference by limiting excessive radiation at frequencies beyond a necessary BW, a spectral mask is applied to HE PPDU based on its BW. Similarly, in IEEE 802.11be EHT WLAN, a spectral mask is applied to EHT PPDU based on its BW. However, it is an open issue regarding how to apply a spectral mask to an A-PPDU (such as a frequency-domain (FD) A-PPDU (FD-A-PPDU)) comprising one or more HE PPDUs or one or more EHT PPDUs.

Therefore, there is a need for an access point (AP), a station (STA), and a wireless communication method, which can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

### SUMMARY

An object of the present disclosure is to propose an access point (AP), a station (STA), and a wireless communication method, which can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

In a first aspect of the present disclosure, a wireless communication method comprises configuring, by an access point (AP), an aggregated physical layer protocol data unit (A-PPDU) comprising one or more high efficiency (HE) PPDUs and/or one or more extremely high throughput (EHT) PPDUs; and determining if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

In a second aspect of the present disclosure, a wireless communication method comprises determining, by a station (STA), an aggregated physical layer protocol data unit (A-PPDU) comprising one or more high efficiency (HE) PPDUs and/or one or more extremely high throughput (EHT) PPDUs, from an access point (AP), wherein if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

In a third aspect of the present disclosure, an access point (AP) comprises a memory, a transceiver, and a processor coupled to the memory and the transceiver. The processor is configured to configure an aggregated physical layer protocol data unit (A-PPDU) comprising one or more high efficiency (HE) PPDUs and/or one or more extremely high throughput (EHT) PPDUs, and the processor is configured to determine if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

In a fourth aspect of the present disclosure, a station (STA) comprises a memory, a transceiver, and a processor coupled to the memory and the transceiver. The processor is configured to determine an aggregated physical layer protocol data unit (A-PPDU) comprising one or more high efficiency (HE) PPDUs and/or one or more extremely high throughput (EHT) PPDUs from an access point (AP), wherein if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF THE DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of 320 MHz bandwidth (BW) frequency-domain (FD) aggregated physical layer (PHY) protocol data unit (A-PPDU) (FD-A-PPDU) according to an embodiment of the present disclosure.

FIG. 2A is a schematic diagram illustrating an example of high efficiency (HE) multi-user (MU) PPDU format according to an embodiment of the present disclosure.

FIG. 2B is a schematic diagram illustrating an example of HE trigger-based (TB) PPDU format according to an embodiment of the present disclosure.

FIG. 3A is a schematic diagram illustrating an example of extremely high throughput (EHT) MU PPDU format according to an embodiment of the present disclosure.

FIG. 3B is a schematic diagram illustrating an example of EHT TB PPDU format according to an embodiment of the present disclosure.

FIG. 4 is a schematic diagram illustrating an example of a wireless communications system according to an embodiment of the present disclosure.

FIG. 5 is a schematic diagram illustrating an example of a wireless communications system according to another embodiment of the present disclosure.

FIG. 6 is a schematic diagram illustrating an example of a wireless communications system according to another embodiment of the present disclosure.

FIG. 7 is a block diagram of one or more stations (STAs) and an access point (AP) of communication in a wireless communications system according to an embodiment of the present disclosure.

FIG. 8 is a flowchart illustrating a wireless communication method performed by an AP according to an embodiment of the present disclosure.

FIG. 9 is a flowchart illustrating a wireless communication method performed by a STA according to another embodiment of the present disclosure.

FIG. 10 is a schematic diagram illustrating an example of 160 MHz BW FD-A-PPDU according to an embodiment of the present disclosure.

FIG. 11A is a schematic diagram illustrating an example of 320 MHz BW FD-A-PPDU in an EHT basic service set (BSS) (Option 1A) according to an embodiment of the present disclosure.

FIG. 11B is a schematic diagram illustrating an example of 320 MHz BW FD-A-PPDU in an EHT BSS (Option 1B) according to an embodiment of the present disclosure.

FIG. 11C is a schematic diagram illustrating an example of 320 MHz BW FD-A-PPDU in an EHT BSS (Option 1C) according to an embodiment of the present disclosure.

FIG. 11D is a schematic diagram illustrating an example of 320 MHz BW FD-A-PPDU in an EHT basic service set (BSS) (Option 1D) according to an embodiment of the present disclosure.

FIG. 11E is a schematic diagram illustrating an example of 320 MHz BW FD-A-PPDU in an EHT basic service set (BSS) (Option 1E) according to an embodiment of the present disclosure.

FIG. 12 is a schematic diagram illustrating an example of interim transmit spectral mask for 160 MHz mask FD-A-PPDU according to an embodiment of the present disclosure.

FIG. 13 is a schematic diagram illustrating an example of interim transmit spectral mask for 320 MHz mask FD-A-PPDU according to an embodiment of the present disclosure.

FIG. 14 is a schematic diagram illustrating an example of preamble puncture mask for preamble puncturing at an edge of a FD-A-PPDU according to an embodiment of the present disclosure.

FIG. 15A, FIG. 15B, and FIG. 15C are schematic diagrams illustrating an example of construction of an overall spectral mask for 160 MHz FD-A-PPDU with lowest and highest 20 MHz subchannels punctured according to an embodiment of the present disclosure.

FIG. 16 is a schematic diagram illustrating an example of preamble puncture mask for preamble puncturing in a middle of a FD-A-PPDU when a BW of a punctured subchannel is equal to or greater than 40 MHz according to an embodiment of the present disclosure.

FIG. 17A, FIG. 17B, and FIG. 17C are a schematic diagram illustrating an example of a construction of an overall spectral mask for 160 MHz FD-A-PPDU with a second lowest 40 MHz subchannel punctured according to an embodiment of the present disclosure.

FIG. 18 is a schematic diagram illustrating an example of preamble puncture mask for preamble puncturing in a middle of a FD-A-PPDU when a BW of a punctured subchannel is equal to 20 MHz according to an embodiment of the present disclosure.

FIG. 19A, FIG. 19B, and FIG. 19C are a schematic diagram illustrating an example of construction of an overall spectral mask for 160 MHz FD-A-PPDU with a fourth lowest 20 MHz subchannel punctured according to an embodiment of the present disclosure.

FIG. 20 is a schematic diagram illustrating an example of transmit spectral mask for N×20 MHz preamble punctured channel with transmissions on both upper and lower subchannels where N is a number of 20 MHz punctured subchannels within a BW allocated to one or more HE PPDUs in a FD-A-PPDU according to an embodiment of the present disclosure.

FIG. 21A, FIG. 21B, and FIG. 21C are a schematic diagram illustrating an example of construction of an overall spectral mask for 160 MHz FD-A-PPDU with the lowest 20 MHz subchannel punctured from 80 MHz HE PPDU and the highest 20 MHz subchannel punctured from 80 MHz EHT PPDU according to an embodiment of the present disclosure.

FIG. 22 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Institute of electrical and electronics engineers (IEEE) 802.11be extremely high throughput (EHT) wireless local area network (WLAN) supports a bandwidth (BW) up to 320 MHz. It is expected that high efficiency (HE) stations (STAs) will exist with extremely high throughput (EHT) STAs in a same EHT basic service set (BSS). In order to maximize throughput of an EHT BSS with large BW (e.g. 320 MHz), an aggregated physical layer (PHY) protocol data unit (A-PPDU) (such as a frequency-domain (FD) A-PPDU (FD-A-PPDU)) in some embodiments of the present disclosure has been proposed.

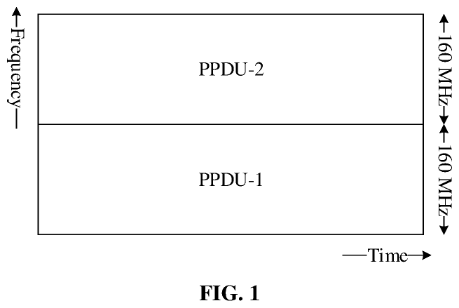

FIG. 1 illustrates an example of 320 MHz bandwidth (BW) frequency-domain (FD) aggregated physical layer (PHY) protocol data unit (A-PPDU) (FD-A-PPDU) according to an embodiment of the present disclosure. FIG. 1 illustrates that the FD-A-PPDU consists of multiple PPDUs. Each PPDU occupies one or more non-overlapping 80 MHz frequency segments. The PPDUs are orthogonal in frequency domain symbol-by-symbol. Each PPDU can have different PPDU formats, e.g. HE PPDU, EHT PPDU, etc.

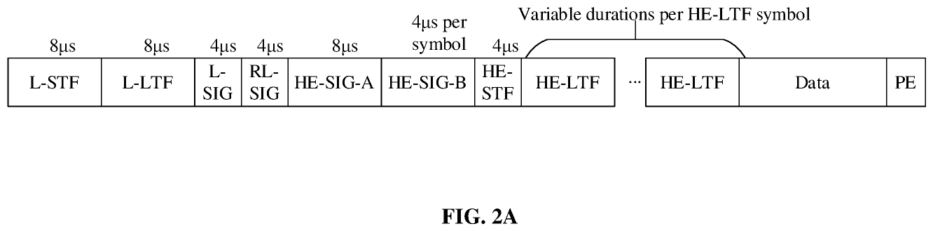

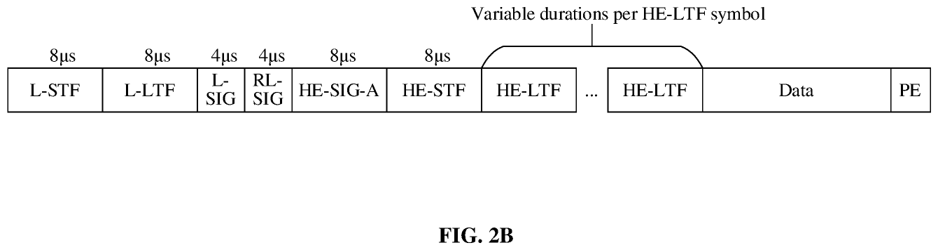

FIG. 2A is illustrates an example of high efficiency (HE) multi-user (MU) PPDU format according to an embodiment of the present disclosure. FIG. 2B illustrates an example of HE trigger-based (TB) PPDU format according to an embodiment of the present disclosure. FIG. 2A and FIG. 2B illustrate that HE PPDU has two main formats: HE MU PPDU and HE TB PPDU. The HE MU PPDU format as illustrated in FIG. 2A is used for transmission to one or more users if the PPDU is not a response of a trigger frame. The HE TB PPDU format as illustrated in FIG. 2B is used for a transmission that is a response to a trigger frame from an access point (AP). A duration of a HE-STF field in the HE TB PPDU is twice a duration of a HE-STF field in the HE MU PPDU. A HE-SIG-B field is present in the HE MU PPDU but is absent from the HE TB PPDU. In a HE MU PPDU, L-STF, L-LTF, L-SIG, RL-SIG, HE-SIG-A and HE-SIG-B are called pre-HE modulated fields while HE-STF, HE-LTF, data field, and PE field are called HE modulated fields. In a HE TB PPDU, L-STF, L-LTF, L-SIG field, RL-SIG field, and HE-SIG-A field are called pre-HE modulated fields while HE-STF, HE-LTF, data field, and PE field are called HE modulated fields. For a HE PPDU, each HE-LTF symbol has the same GI duration as each data symbol, which is 0.8 μs, 1.6 μs, or 3.2 μs. The HE-LTF field comprises three types: 1× HE-LTF, 2× HE-LTF, and 4× HE-LTF. The duration of each 1× HE-LTF, 2× HE-LTF, or 4× HE-LTF symbol without GI is 3.2 μs, 6.4 μs, or 12.8 μs. Only 2× HE-LTF and 4× HE-LTF are supported in the HE MU PPDU. Each data symbol without GI is 12.8 μs. The PE field duration of a HE PPDU is 0 μs, 4 μs, 8 μs, 12 μs, or 16 μs.

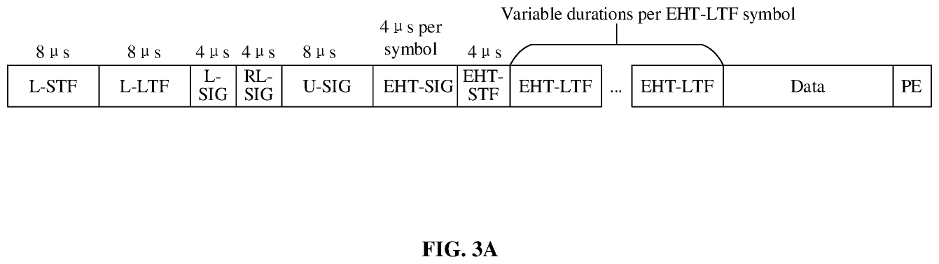

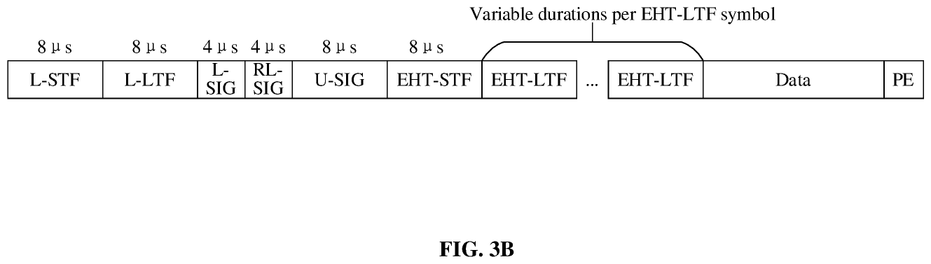

FIG. 3A illustrates an example of extremely high throughput (EHT) MU PPDU format according to an embodiment of the present disclosure. FIG. 3B illustrates an example of EHT TB PPDU format according to an embodiment of the present disclosure. FIG. 3A and FIG. 3B illustrate that EHT PPDU has two formats: EHT MU PPDU and EHT TB PPDU. The EHT MU PPDU format as illustrated in FIG. 3A is used for transmission to one or more users if a PPDU is not a response of a trigger frame. EHT-SIG field is present in the EHT MU PPDU. The EHT TB PPDU format as illustrated in FIG. 3B is used for a transmission that is a response to a trigger frame from an AP. EHT-SIG field is not present in the EHT TB PPDU. A duration of an EHT-STF field in the EHT TB PPDU is twice a duration of an EHT-STF field in the EHT MU PPDU. In an EHT MU PPDU, L-STF, L-LTF, L-SIG, RL-SIG field, U-SIG field, and EHT-SIG field are called pre-EHT modulated fields while EHT-STF, EHT-LTF, data field, and PE field are called EHT modulated fields. In an EHT TB PPDU, L-STF, L-LTF, L-SIG field, RL-SIG field, and U-SIG field are called pre-EHT modulated fields while EHT-STF, EHT-LTF, data field, and PE field are called EHT modulated fields. For an EHT PPDU, each EHT-LTF symbol has the same GI duration as each data symbol, which is 0.8 μs, 1.6 μs, or 3.2 μs. EHT-LTF field comprises three types: 1× EHT-LTF, 2× EHT-LTF, and 4× EHT-LTF. The duration of each 1× EHT-LTF, 2× EHT-LTF, or 4× EHT-LTF symbol without GI is 3.2 μs, 6.4 μs, or 12.8 μs. Each data symbol without GI is 12.8 μs. The PE field duration of an EHT PPDU is 0 μs, 4 μs, 8 μs, 12 μs, 16 μs, or 20 μs.

In an EHT BSS, HE MU PPDU and EHT MU PPDU can be used for downlink MU transmission. On the other hand, HE TB PPDU and EHT TB PPDU can be used for uplink MU transmission.

The following description is directed to certain implementations for the purposes of describing the innovative aspects of the present disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), global system for mobile communications (GSM), GSM/general packet radio service (GPRS), enhanced data GSM environment (EDGE), terrestrial trunked radio (TETRA), wideband-CDMA (W-CDMA), evolution data optimized (EV-DO), 1×EV-DO, EV-DO Rev A, EV-DO Rev B, high speed packet access (HSPA), high speed downlink packet access (HSDPA), high speed uplink packet access (HSUPA), evolved high speed packet access (HSPA+), long term evolution (LTE), AMPS, or other known signals that are used to communicate within a wireless, cellular or internet of things (IOT) network, such as a system utilizing 3G, 4G, or 5G, or further implementations thereof, technology.

Techniques are disclosed for wireless devices to support multiplexing clients of different generations in trigger-based transmissions. For example, an access point (AP) that supports multiple generations of station (STA) may support uplink transmissions in, for example, an extremely high throughput (EHT) wireless communications system. EHT systems also may be referred to as ultra-high throughput (UHT) systems, next generation Wi-Fi systems, or next big thing (NBT) systems, and may support coverage for multiple types of mobile stations (STAs). For example, an AP in an EHT system may provide coverage for EHT STAs, as well as legacy (or high efficiency (HE)) STAs. The AP may multiplex boy EHT STAs and HE STAs in trigger-based uplink transmissions. That is, the AP may operate using techniques to provide backwards compatibility for HE STAs, while providing additional functionality for EHT STAs.

To trigger uplink transmissions from one or more STAs of different generations, the AP may transmit a trigger frame. The trigger frame may be formatted as a legacy trigger frame so that HE STAs may detect and process the trigger frame to determine uplink transmissions. The AP may include resource unit (RU) allocations in the trigger frame. An STA may receive the trigger frame, identify the RU allocation corresponding to that STA, and may transmit an uplink transmission to the AP using the allocated resources. Legacy STAs may support transmitting in a narrower bandwidth (for example, 160 megahertz (MHz)) than EHT STAs (which may transmit in a 320 MHz bandwidth). The AP may include an additional indication in the trigger frame for EHT STAs, so that the EHT STAs may identify the bandwidth to use (for example, the legacy bandwidth or the greater EHT bandwidth).

In some implementations, the AP and EHT STAs may use a new EHT RU allocation table when operating in the larger bandwidth. An EHT STA receiving the trigger frame may use a same RU allocation field as HE STAs to determine the RU allocation index, but may use a different table to look up an entry corresponding to the RU allocation index. In some other implementations, the AP may include an additional bit in the trigger frame to indicate to EHT STAs whether to use a primary or a secondary 160 MHz portion of the 320 MHz bandwidth. The EHT STAs may use a legacy RU allocation table, which also may include an additional entry corresponding to this wider bandwidth. In yet some other implementations, the AP may order the RU allocations in the trigger frame in increasing order. An EHT STA may parse the user information for multiple STAs, and may sum the allocated resources for each STA preceding the resource allocation for that EHT STA. The EHT STA may determine the resources for transmission based on the sum and the ordering of the allocations. In each of these implementations, legacy STAs may utilize legacy operations to determine a bandwidth for transmission based on a bandwidth field in the trigger frame. Additionally, if the trigger frame does not indicate the wider EHT bandwidth, an EHT STA may utilize this legacy bandwidth field to determine the resources for transmission.

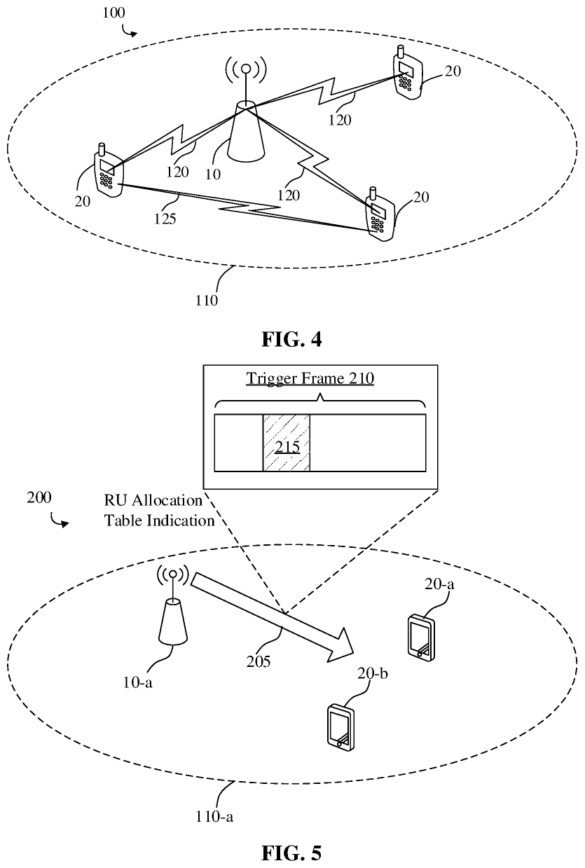

FIG. 4 illustrates an example of a wireless communications system according to an embodiment of the present disclosure. The wireless communications system may be an example of a wireless local area network (WLAN) 100 (also known as a Wi-Fi network) (such as next generation, next big thing (NBT), ultra-high throughput (UHT) or EHT Wi-Fi network) configured in accordance with various aspects of the present disclosure. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, a STA 20 may be located in the intersection of more than one coverage area 110 and may associate with more than one AP 10. A single AP 10 and an associated set of STAs 20 may be referred to as a BSS. An ESS is a set of connected BSSs. A distribution system (not shown) may be used to connect APs 10 in an ESS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 120 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11 ay, etc. In some other implementations, peer-to-peer connections or ad hoc networks may be implemented within the WLAN 100.

FIG. 5 illustrates an example of a wireless communications system according to another embodiment of the present disclosure. The wireless communications system 200 may be an example of a next generation or EHT Wi-Fi system, and may include an AP 10-a and STAs 20-a and 20-b, and a coverage area 110-a, which may be examples of components described with respect to FIG. 4. The AP 10-a may transmit a trigger frame 210 including an RU allocation table indication 215 on the downlink 205 to the STAs 20.

In some implementations, a wireless communications system 200 may be a next generation Wi-Fi system (such as, an EHT system). In some implementations, wireless communications system 200 may also support multiple communications systems. For instance, wireless communications system 200 may support EHT communications and HE communications. In some implementations, the STA 20-a and the STA 20-b may be different types of STAs. For example, the STA 20-a may be an example of an EHT STA, while the STA 20-b may be an example of an HE STA. The STA 20-b may be referred to as a legacy STA.

In some instances, EHT communications may support a larger bandwidth than legacy communications. For instance, EHT communications may occur over an available bandwidth of 320 MHz, whereas legacy communications may occur over an available bandwidth of 160 MHz. Additionally, EHT communications may support higher modulations than legacy communications. For instance, EHT communications may support 4K quadrature amplitude modulation (QAM), whereas legacy communications may support 1024 QAM. EHT communications may support a larger number of spatial streams (such as, space-time-streams) than legacy systems. In one non-limiting illustrative example, EHT communications may support 16 spatial streams, whereas legacy communications may support 8 spatial streams. In some cases, EHT communications may occur a 2.4 GHz channel, a 5 GHz channel, or a 6 GHz channel in unlicensed spectrum.

In some implementations, AP 10-a may transmit a trigger frame 210 to one or more STAs 20 (such as, STA 20-a and STA 20-b). In some implementations, the trigger frame may solicit an uplink transmission from the STAs 20. However, the trigger frame 210 may be received by an EHT STA 20-a and HE STA 20-b. The trigger frame 210 may be configured to solicit an uplink transmission from only HE STAs 20-b. In some implementations, trigger frame 210 may be configured to solicit an uplink transmission from EHT STAs 20-a. In some other implementations, the trigger frame 210 may be configured to solicit an uplink transmission from one or more EHT STAs 20-a and one or more HE STAs 20-b.

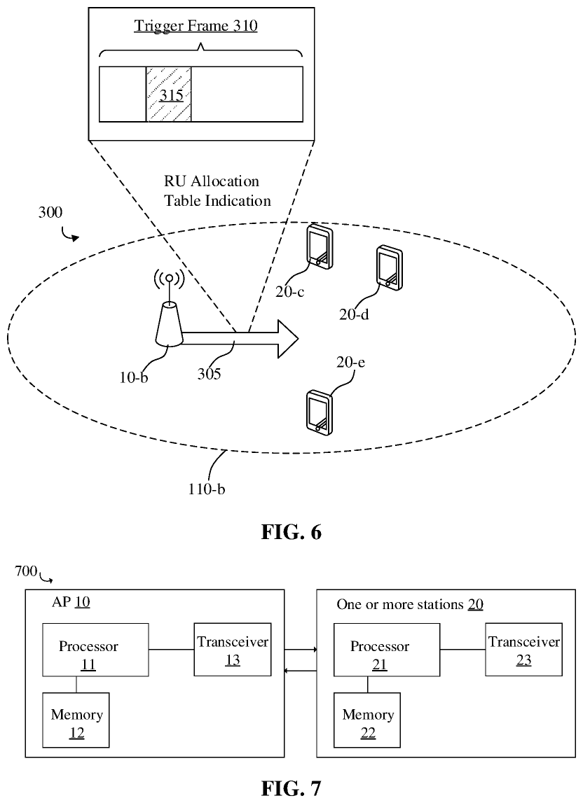

FIG. 6 illustrates an example of a wireless communications system according to another embodiment of the present disclosure. The wireless communications system 300 may be an example of a post-EHT Wi-Fi system, and may include an AP 10-b. AP 10-b may be an example of a post-EHT AP 10. The wireless communications system 300 may include HE STA 20-c, EHT STA 20-d, and post-EHT STA 20-e, and a coverage area 110-b, which may be examples of components described with respect to FIGS. 5 and 6. The AP 10-b may transmit a trigger frame 310 including an RU allocation table indication 315 on the downlink 305 to the STAs 20. In some implementations, STAs 20 may be referred to as clients.

In some implementations, an EHT AP 10 may serve both HE STAs 20 and EHT STAs 20. The EHT AP 10 may send a trigger frame that may trigger a response from HE STAs 20 only, from EHT STAs 20 only, or from both HE STAs 20 and EHT STAs 20. STAs 20 that are scheduled in the trigger frame may respond with trigger-based PPDUs. In some implementations, an EHT AP 10 may trigger HE STAs 20 (and not EHT STAs 20) by sending an HE trigger frame format. In some implementations, an EHT AP 10 may trigger EHT STAs 20 (and not EHT STAs 20) by sending an HE trigger frame format or an HE trigger frame format including some field or bit allocation adjustments. In some implementations, an EHT AP 10 may trigger EHT STAs 20 and HE STAs 20 by sending an HE trigger frame format including some field or bit allocation adjustments.

The trigger frame 310 may solicit a response from one or more EHT STAs 20 or one or more HE STAs 20, or both. In some implementations, STAs 20 may not transmit unsolicited uplink transmissions in response to trigger frame 310. In some implementations, trigger frame 310 may solicit an uplink orthogonal frequency division multiple access (OFDMA) transmission or an OFDMA with multi-user multiple-input multiple-output (MU-MIMO) transmission.

FIG. 7 illustrates one or more stations (STAs) 20 and an access point (AP) 10 of communication in a wireless communications system 700 according to an embodiment of the present disclosure. FIG. 7 illustrates that, the wireless communications system 700 includes an access point (AP) 10 and one or more stations (STAs) 20. The AP 10 may include a memory 12, a transceiver 13, and a processor 11 coupled to the memory 12, the transceiver 13. The one or more STAs 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to configure an aggregated physical layer protocol data unit (A-PPDU) comprising one or more high efficiency (HE) PPDUs and/or one or more extremely high throughput (EHT) PPDUs, and the processor 11 is configured to determine if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU. This can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

In some embodiments, the processor 21 is configured to determine an aggregated physical layer protocol data unit (A-PPDU) comprising one or more high efficiency (HE) PPDUs and/or one or more extremely high throughput (EHT) PPDUs from an access point (AP), wherein if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU. This can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

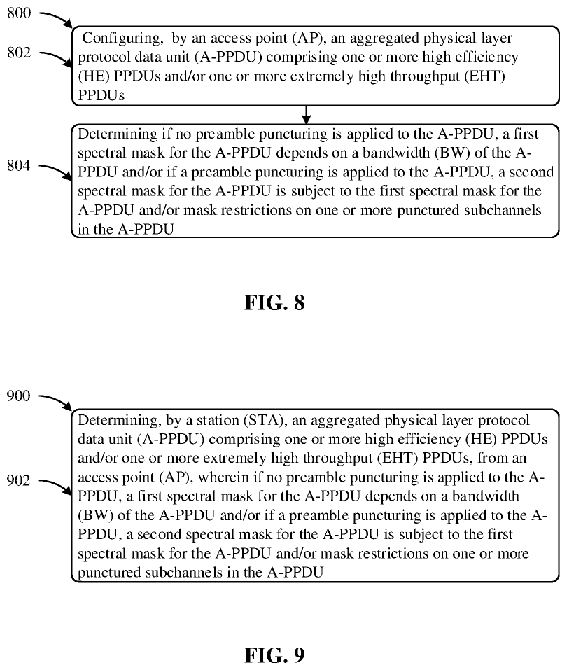

FIG. 8 illustrates a wireless communication method 800 performed by an AP according to an embodiment of the present disclosure. In some embodiments, the method 800 includes: a block 802, configuring, by an access point (AP), an aggregated physical layer protocol data unit (A-PPDU) comprising one or more high efficiency (HE) PPDUs and/or one or more extremely high throughput (EHT) PPDUs, and a block 804, determining if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU. This can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

FIG. 9 illustrates a wireless communication method 900 performed by a STA according to an embodiment of the present disclosure. In some embodiments, the method 900 includes: a block 902, determining, by a station (STA), an aggregated physical layer protocol data unit (A-PPDU) comprising one or more high efficiency (HE) PPDUs and/or one or more extremely high throughput (EHT) PPDUs, from an access point (AP), wherein if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU. This can solve issues in the prior art, apply an appropriate spectral mask to an A-PPDU comprising one or more HE PPDUs and/or one or more EHT PPDUs, mitigate interference, reduce adjacent-channel interference by limiting excessive radiation at frequencies beyond a necessary BW, achieve extremely high throughput, provide good communication performance, and/or provide high reliability.

In some embodiments, if no preamble puncturing is applied to the A-PPDU, the first spectral mask for the A-PPDU does not depend on a BW of the one or more HE PPDUs and/or a BW of the one or more EHT PPDUs in the A-PPDU. In some embodiments, the first spectral mask for the A-PPDU is the same as an interim spectral mask for EHT PPDU which has the same BW as the A-PPDU. In some embodiments, the mask restrictions on the one or more punctured subchannels in the A-PPDU are the same as mask restrictions on the one or more punctured subchannels for EHT PPDU. In some embodiments, the one or more punctured subchannels in the A-PPDU result from that a lowest subchannel and/or a highest subchannel is punctured in the A-PPDU. In some embodiments, the one or more punctured subchannels in the A-PPDU result from that two or more contiguous 20 MHz subchannels are punctured in the A-PPDU. In some embodiments, the one or more punctured subchannels in the A-PPDU is equal to 20 MHz and is not at an edge of the A-PPDU. In some embodiments, the mask restrictions on the one or more punctured subchannels in the A-PPDU are different from mask restrictions on the one or more punctured subchannels for EHT PPDU. In some embodiments, whether the mask restrictions on the one or more punctured subchannels in the A-PPDU are the same as or different from the mask restrictions on the one or more punctured subchannels for EHT PPDU depends on a location and/or a size of the one or more punctured subchannels in the A-PPDU.

In some embodiments, if the one or more punctured subchannels in the A-PPDU are within the BW allocated to the one or more EHT PPDUs in the A-PPDU or the one or more punctured subchannels in the A-PPDU are an 80 MHz channel punctured from 320 MHz A-PPDU, the mask restrictions on the one or more punctured subchannels in the A-PPDU are the same as the mask restrictions on the one or more punctured subchannels for EHT PPDU. In some embodiments, if the one or more punctured subchannels in the A-PPDU are within the BW allocated to the one or more HE PPDUs in the A-PPDU, the mask restrictions on the one or more punctured subchannels in the A-PPDU are different from the mask restrictions on the one or more punctured subchannels for EHT PPDU. In some embodiments, if the one or more punctured subchannels in the A-PPDU are within the BW allocated to the one or more HE PPDUs in the A-PPDU, the mask restrictions on the one or more punctured subchannels in the A-PPDU are the same as mask restrictions on the one or more punctured subchannels for HE PPDU. In some embodiments, the A-PPDU further comprises one or more post-EHT PPDUs. In some embodiments, if no preamble puncturing is applied to the A-PPDU, the first spectral mask for the A-PPDU does not depend on a BW of the one or more post-EHT PPDUs in the A-PPDU. In some embodiments, the first spectral mask for the A-PPDU is the same as an interim spectral mask for post-EHT PPDU which has the same BW as the A-PPDU. In some embodiments, the mask restrictions on the one or more punctured subchannels in the A-PPDU are the same as mask restrictions on the one or more punctured subchannels for post-EHT PPDU.

In some embodiments, the mask restrictions on the one or more punctured subchannels in the A-PPDU are different from mask restrictions on the one or more punctured subchannels for post-EHT PPDU. In some embodiments, whether the mask restrictions on the one or more punctured subchannels in the A-PPDU are the same as or different from the mask restrictions on the one or more punctured subchannels for post-EHT PPDU depends on a location and/or a size of the one or more punctured subchannels in the A-PPDU. In some embodiments, if the one or more punctured subchannels in the A-PPDU are within the BW allocated to the one or more post-EHT PPDUs in the A-PPDU, the mask restrictions on the one or more punctured subchannels in the A-PPDU are the same as the mask restrictions on the one or more punctured subchannels for post-EHT PPDU. In some embodiments, if the one or more punctured subchannels in the A-PPDU are within the BW allocated to the one or more HE PPDUs in the A-PPDU, the mask restrictions on the one or more punctured subchannels in the A-PPDU are different from the mask restrictions on the one or more punctured subchannels for post-EHT PPDU. In some embodiments, if the one or more punctured subchannels in the A-PPDU are within the BW allocated to the one or more HE PPDUs in the A-PPDU, the mask restrictions on the one or more punctured subchannels in the A-PPDU are the same as the mask restrictions on the one or more punctured subchannels for HE PPDU. In some embodiments, if the one or more punctured subchannels in the A-PPDU are within the BW allocated to the one or more EHT PPDUs in the A-PPDU, the mask restrictions on the one or more punctured subchannels in the A-PPDU are different from the mask restrictions on the one or more punctured subchannels for post-EHT PPDU. In some embodiments, if the one or more punctured subchannels in the A-PPDU are within the BW allocated to the one or more EHT PPDUs in the A-PPDU, the mask restrictions on the one or more punctured subchannels in the A-PPDU are the same as the mask restrictions on the one or more punctured subchannels for EHT PPDU. In some embodiments, the A-PPDU is operated in an extremely high throughput (EHT) wireless local area network (WLAN) or a post-EHT WLAN. In some embodiments, the A-PPDU comprises a frequency-domain (FD) A-PPDU (FD-A-PPDU).

According to some embodiments of the present disclosure, in an EHT BSS with a large BW (e.g. 160 MHz or 320 MHz), a FD-A-PPDU used for downlink transmission may comprise a single HE MU PPDU and one or two EHT MU PPDUs if the number of HE-SIG-B symbols is equal to the number of EHT-SIG symbols; and the HE-LTF field has a same symbol duration and a same GI duration as the EHT-LTF field. The number of HE-LTF symbols may be the same as or different from the number of EHT-LTF symbols. When the number of HE-LTF symbols is the same as the number of EHT-LTF symbols, each HE-LTF/EHT-LTF symbol may have a different duration or a same duration from each data symbol. In other words, each HE-LTF/EHT-LTF symbol without GI may be 6.4 μs or 12.8 μs. When the number of HE-LTF symbols is different from the number of EHT-LTF symbols, each HE-LTF/EHT-LTF symbol shall have a same duration as each data symbol. In other words, each HE-LTF/EHT-LTF symbol without GI shall be 12.8 μs. As a result, the pre-HE modulated fields of a HE MU PPDU and the pre-EHT modulated fields of an EHT MU PPDU can be kept orthogonal in frequency domain symbol-by-symbol.

For downlink transmission, a HE STA only needs to process the pre-HE modulated fields of a HE MU PPDU within primary 80 MHz channel (P80); while an EHT STA only needs to process the pre-EHT modulated fields of an EHT MU PPDU within an 80 MHz frequency segment it parks. As a result, for a FD-A-PPDU comprising a HE PPDU and one or two EHT PPDUs, each intended HE STA shall park in P80 while each intended EHT STA shall park in one of non-primary 80 MHz channel(s) via an enhanced SST mechanism. A non-primary 80 MHz channel is an 80 MHz frequency segment outside P80, e.g. secondary 80 MHz channel (S80) in a 160 MHz or 320 MHz channel.

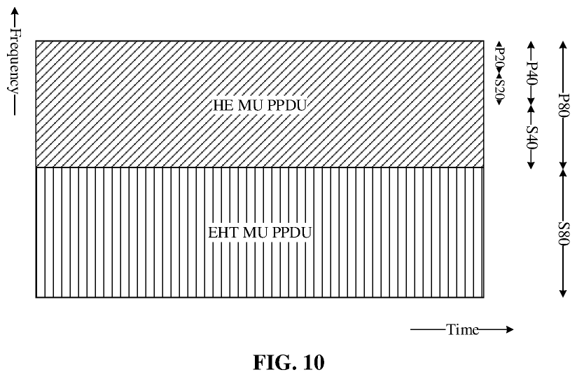

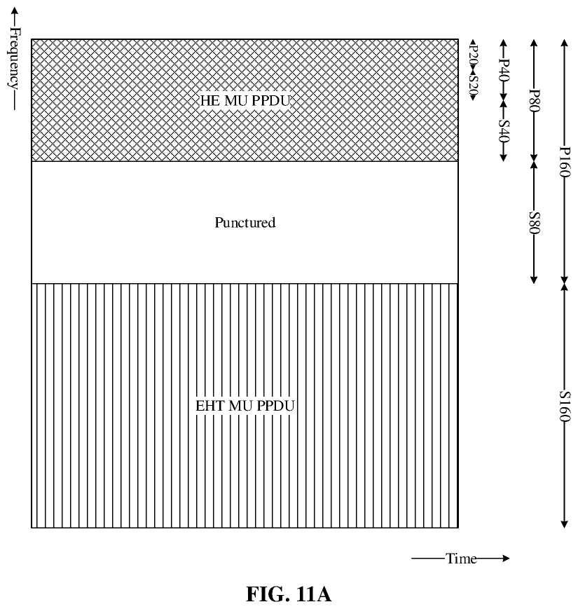

FIG. 10 illustrates that, in some embodiments of the present disclosure, for a 160 MHz BW FD-A-PPDU, a BW allocated to HE MU PPDU is P80 while a BW allocated to EHT MU PPDU is S80. Each intended HE STA shall park in P80 while each intended EHT STA shall park in S80. Any non-primary 20 MHz channel within P80 may be punctured. In this case, an 80 MHz BW HE MU PPDU to which preamble puncturing may be applied is transmitted in P80. On the other hand, any 20 MHz channel or any two consecutive 20 MHz channels within S80 may be punctured. In this case, an 80 MHz BW EHT MU PPDU to which preamble puncturing may be applied is transmitted in S80.

According to some embodiments of the present disclosure, in a 320 MHz BW FD-A-PPDU, a BW allocated to HE MU PPDU is P80 or primary 160 MHz channel (P160); while a BW allocated to EHT MU PPDU is one of two 80 MHz frequency segments of secondary 160 MHz channel (S160), S160, a combination of S80 and one of two 80 MHz frequency segments of S160 or a combination of S80 and S160. The number of EHT MU PPDUs in a 320 MHz BW FD-A-PPDU depends on how the BW is allocated to EHT MU PPDU in the FD-A-PPDU. When the BW allocated to EHT MU PPDU is one of two 80 MHz frequency segments of S160 or S160, there is a single EHT MU PPDU in the FD-A-PPDU. When the BW allocated to EHT MU PPDU is a combination of S80 and one of two 80 MHz frequency segments of S160, there are two EHT MU PPDUs in the FD-A-PPDU. When the BW allocated to EHT MU PPDU is a combination of S80 and S160, there is one EHT MU PPDU in the FD-A-PPDU.

For a 320 MHz BW FD-A-PPDU in an EHT basic service set (BSS), there may have the following five options for BW allocation in the FD-A-PPDU:

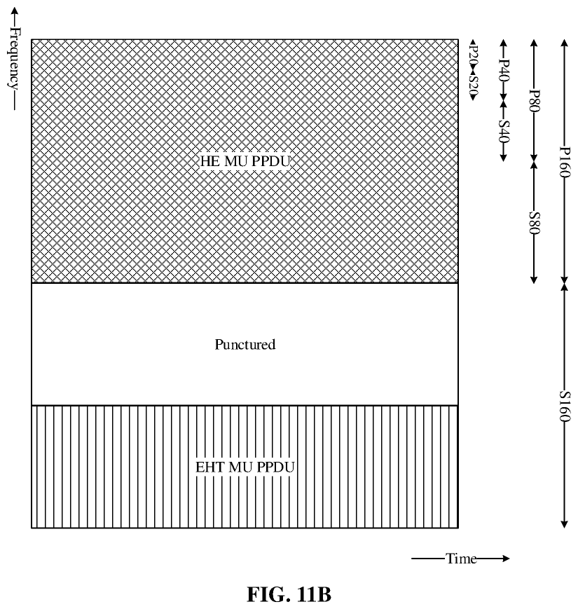

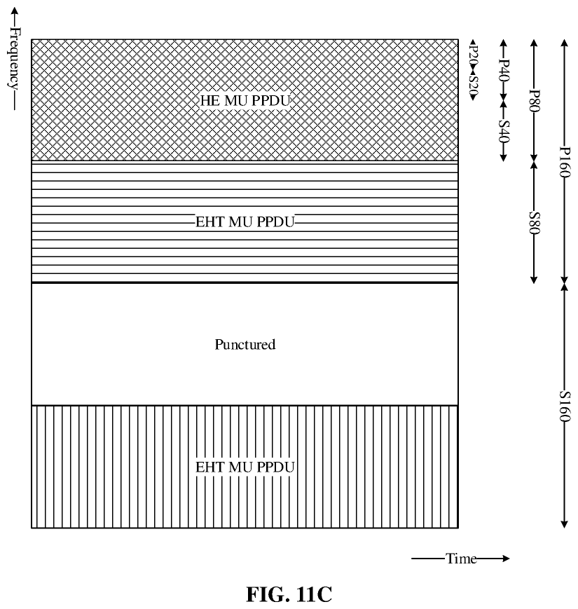

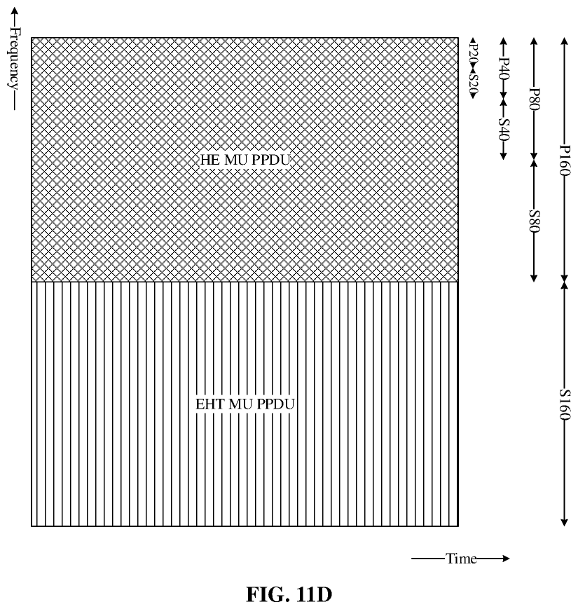

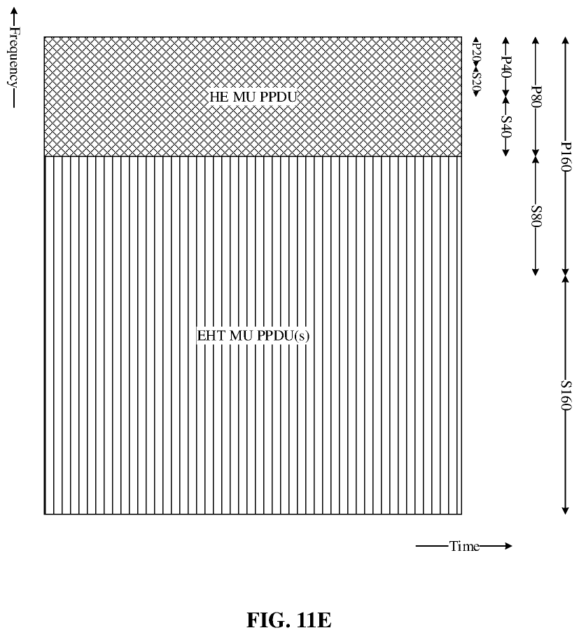

Option 1A: When S80 is punctured, BW allocated to HE MU PPDU is P80 and BW allocated to EHT MU PPDU is S160, as illustrated in FIG. 11A.

Option 1B: When one of two 80 MHz frequency segments of S160 is punctured, BW allocated to HE MU PPDU is P160 and BW allocated to EHT MU PPDU is the other 80 MHz frequency segment of S160, as illustrated in FIG. 11B.

Option 1C: When one of two 80 MHz frequency segments of S160 is punctured, BW allocated to HE MU PPDU is P80 and BW allocated to EHT MU PPDU is S80 and the other 80 MHz frequency segment of S160, as illustrated in FIG. 11C.

Option 1D: When none of 80 MHz frequency segments is punctured, BW allocated to HE MU PPDU is P160 and BW allocated to EHT MU PPDU is S160, as illustrated in FIG. 11D.

Option 1E: When none of 80 MHz frequency segments is punctured, BW allocated to HE MU PPDU is P80 and BW allocated to EHT MU PPDU is S80 and S160, as illustrated in FIG. 11E.

FIG. 11A illustrates that, according to some embodiments of the present disclosure, regarding Option 1A for a 320 MHz BW FD-A-PPDU, each intended HE STA shall park in P80 while each intended EHT STA shall park in one of two 80 MHz frequency segments of S160. Within P80, any non-primary 20 MHz channel may be punctured. In this case, an 80 MHz BW HE MU PPDU to which preamble puncturing may be applied is transmitted in P80. Within each of 80 MHz frequency segments of S160, any 20 MHz channel or any two consecutive 20 MHz channels may be punctured. In this case, a 160 MHz BW EHT MU PPDU to which preamble puncturing may be applied is transmitted in S160.

FIG. 11B illustrates that, according to some embodiments of the present disclosure, regarding Option 1B for a 320 MHz BW FD-A-PPDU, each intended HE STA shall park in P80 while each intended EHT STA shall park in the unpunctured 80 MHz frequency segment of S160. Within P160, any non-primary 20 MHz channel and/or any non-primary 40 MHz channel may be punctured. In this case, a 160 MHz BW HE MU PPDU to which preamble puncturing may be applied is transmitted in P160. Within the unpunctured 80 MHz frequency segment of S160, any 20 MHz channel or any two consecutive 20 MHz channels may be punctured. In this case, an 80 MHz BW EHT MU PPDU with preamble puncturing applied is transmitted in the unpunctured 80 MHz frequency segment of S160.

FIG. 11C illustrates that, according to some embodiments of the present disclosure, regarding Option 1C for a 320 MHz BW FD-A-PPDU, each intended HE STA shall park in P80 while each intended EHT STA shall park in S80 or the unpunctured 80 MHz frequency segment of S160. Within P80, any non-primary 20 MHz channel may be punctured. In this case, an 80 MHz BW HE MU PPDU to which preamble puncturing may be applied is transmitted in P80. On the other hand, within S80 or the unpunctured 80 MHz frequency segment of S160, any 20 MHz channel or any two consecutive 20 MHz channels may be punctured. In this case, a first 80 MHz BW EHT MU PPDU to which preamble puncturing may be applied is transmitted in S80; and a second 80 MHz BW EHT MU PPDU to which preamble puncturing may be applied is transmitted in the unpunctured 80 MHz frequency segment of S160.

FIG. 11D illustrates that, according to some embodiments of the present disclosure, regarding Option 1D for a 320 MHz BW FD-A-PPDU, each intended HE STA shall park in P80 while each intended EHT STA shall park in one of two 80 MHz frequency segments of S160. Within P160, any non-primary 20 MHz channel and/or any non-primary 40 MHz channel may be punctured. In this case, a 160 MHz BW HE MU PPDU to which preamble puncturing may be applied is transmitted in P160. On the other hand, within each of 80 MHz frequency segments of S160, any 20 MHz channel or any two consecutive 20 MHz subchannels may be punctured. In this case, a 160 MHz BW EHT MU PPDU to which preamble puncturing may be applied is transmitted in S160.

FIG. 11E illustrates that, according to some embodiments of the present disclosure, regarding Option 1E for a 320 MHz BW FD-A-PPDU, each intended HE STA shall park in P80 while each intended EHT STA shall park in S80 or one of two 80 MHz frequency segments of S160. Within P80, any non-primary 20 MHz channel may be punctured. In this case, an 80 MHz BW HE MU PPDU to which preamble puncturing may be applied is transmitted in P80. Within S80 or each of 80 MHz frequency segments of S160, any 20 MHz channel or any two consecutive 20 MHz channels may be punctured. In this case, a 320 MHz BW HE MU PPDU to which preamble puncturing may be applied is transmitted in S80 and S160.

According to some embodiments of the present disclosure, in an EHT BSS with a large BW (e.g. 160 MHz or 320 MHz), a TB FD-A-PPDU used for uplink MU transmission may comprise one HE TB PPDU and one or more EHT TB PPDUs if the HE-LTF field has a same symbol duration and a same GI duration as the EHT-LTF field. The number of HE-LTF symbols may be the same as or different from the number of EHT-LTF symbols. When the number of HE-LTF symbols is the same as the number of EHT-LTF symbols, each HE-LTF/EHT-LTF symbol may have a different duration or a same duration from each data symbol. In other words, each HE-LTF/EHT-LTF symbol without GI may be 6.4 μs or 12.8 μs. When the number of HE-LTF symbols is different from the number of EHT-LTF symbols, each HE-LTF/EHT-LTF symbol shall have a same duration as each data symbol. In other words, each HE-LTF/EHT-LTF symbol without GI shall be 12.8 μs. As a result, the pre-HE modulated fields of a HE TB PPDU and the pre-EHT modulated fields of an EHT TB PPDU can be kept orthogonal in frequency domain symbol-by-symbol.

For uplink MU transmission, each scheduled HE STA may park in P80; while each scheduled EHT STA may park in one of non-primary 80 MHz channel(s) via an enhanced SST mechanism. A non-primary 80 MHz channel is an 80 MHz frequency segment outside P80, e.g. S80 in a 160 MHz or 320 MHz channel.

According to some embodiments of the present disclosure, for a 160 MHz BW FD-A-PPDU, BW allocated to HE TB PPDU is P80 while BW allocated to EHT TB PPDU is S80. In this case, one HE TB PPDU may be transmitted in P80 while one EHT TB PPDU may be transmitted in S80.

According to some embodiments of the present disclosure, in a 320 MHz BW TB FD-A-PPDU, the BW allocated to HE TB PPDU is P80 or primary 160 MHz channel (P160); while the BW allocated to EHT TB PPDU is one of two 80 MHz frequency segments of secondary 160 MHz channel (S160), S160, a combination of S80 and one of two 80 MHz frequency segments of S160 or a combination of S80 and S160. For a 320 MHz BW FD-A-PPDU, there may have the following five options for BW allocation in the TB FD-A-PPDU:

Option 2A: When S80 is punctured, BW allocated to HE TB PPDU is P80 and BW allocated to EHT TB PPDU is S160. One HE TB PPDU may be transmitted in P80 while one EHT TB PPDU may be transmitted in S160.

Option 2B: When one of two 80 MHz frequency segments of S160 is punctured, BW allocated to HE TB PPDU is P160 and BW allocated to EHT TB PPDU is the other 80 MHz frequency segment of S160. One HE TB PPDU may be transmitted in P160 while one EHT TB PPDU may be transmitted in the unpunctured 80 MHz frequency segment of S160.

Option 2C: When one of two 80 MHz frequency segments of S160 is punctured, BW allocated to HE TB PPDU is P80 and BW allocated to EHT TB PPDU is S80 and the other 80 MHz frequency segment of S160. One HE TB PPDU may be transmitted in P80 while two EHT TB PPDUs may be transmitted in S80 and the unpunctured 80 MHz frequency segment of S160, respectively.

Option 2D: When none of 80 MHz frequency segments is punctured, BW allocated to HE TB PPDU is P160 and BW allocated to EHT TB PPDU is S160. One HE TB PPDU may be transmitted in P160 while one EHT TB PPDU may be transmitted in S160.

Option 2E: When none of 80 MHz frequency segments is punctured, BW allocated to HE TB PPDU is P80 and BW allocated to EHT TB PPDU is S80 and S160. One HE TB PPDU may be transmitted in P80 while one EHT TB PPDU may be transmitted in S80 and S160.

Method for Applying Spectral Mask to FD-A-PPDU:

According to some embodiments of the present disclosure, if no preamble puncturing is applied for FD-A-PPDU comprising one or more HE PPDUs and one or more EHT PPDUs, how an interim transmit spectral mask is applied to the FD-A-PPDU depends on the FD-A-PPDU's BW, regardless of respective BW of the one or more HE PPDUs and the one or more EHT PPDUs in the FD-A-PPDU. An interim transmit spectral mask for EHT PPDU is reused for FD-A-PPDU that has the same BW as the EHT PPDU. In other words, the interim transmit spectral mask for 160 MHz mask EHT PPDU is reused for 160 MHz mask FD-A-PPDU; and the interim transmit spectral mask for 320 MHz mask EHT PPDU is reused for 320 MHz mask FD-A-PPDU.

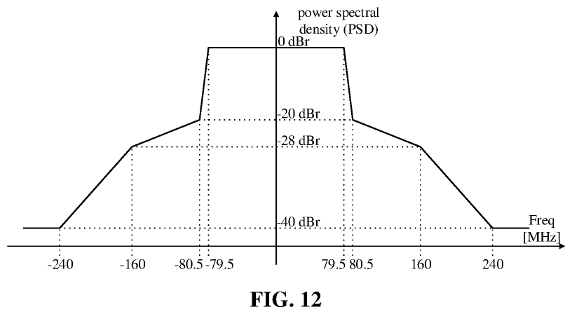

FIG. 12 illustrates an example of interim transmit spectral mask for 160 MHz mask FD-A-PPDU according to an embodiment of the present disclosure. FIG. 12 illustrates that, in some embodiments, for 160 MHz mask FD-A-PPDU, if preamble puncturing is not applied, the interim transmit spectral mask shall have a 0 dBr (dB relative to the maximum spectral density of the signal) BW of 159 MHz, −20 dBr at 80.5 MHz frequency offset, −28 dBr at 160 MHz frequency offset, and −40 dBr at 240 MHz frequency offset and above. The interim transmit spectral mask for frequency offsets in between 79.5 and 80.5 MHz, 80.5 and 160 MHz, and 160 and 240 MHz shall be linearly interpolated in dB domain from the requirements for 79.5 MHz, 80.5 MHz, 160 MHz, and 240 MHz frequency offsets. The transmit spectrum shall not exceed the maximum of the interim transmit spectrum mask and −59 dBm/MHz at any frequency offset. FIG. 12 illustrates an example of the resulting overall spectral mask when the −40 dBr spectrum level is above −59 dBm/MHz.

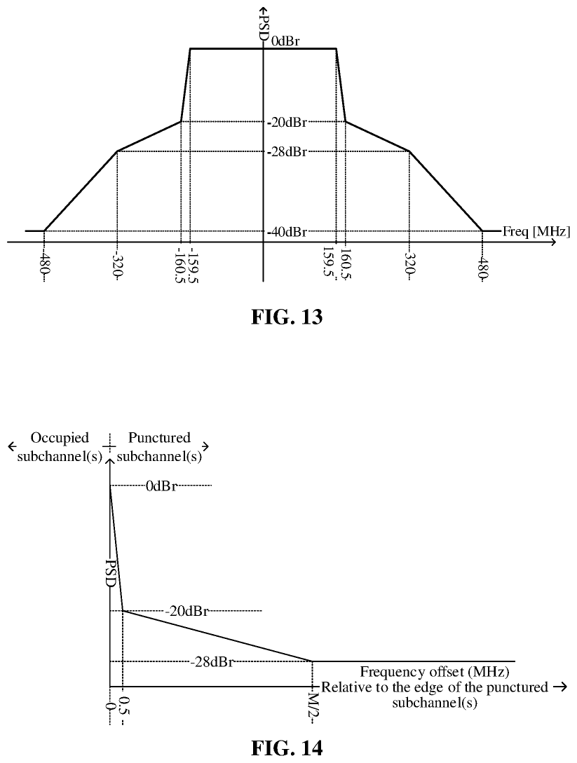

FIG. 13 illustrates an example of interim transmit spectral mask for 320 MHz mask FD-A-PPDU according to an embodiment of the present disclosure. FIG. 13 illustrates that, in some embodiments, for 320 MHz mask FD-A-PPDU, if the preamble puncturing is not applied, the interim transmit spectral mask shall have a 0 dBr (dB relative to the maximum spectral density of the signal) BW of 319 MHz, −20 dBr at 160.5 MHz frequency offset, −28 dBr at 320 MHz frequency offset, and −40 dBr at 480 MHz frequency offset and above. The interim transmit spectral mask for frequency offsets in between 159.5 and 160.5 MHz, 160.5 and 320 MHz, and 320 and 480 MHz shall be linearly interpolated in dB domain from the requirements for 159.5 MHz, 160.5 MHz, 320 MHz, and 480 MHz frequency offsets. The transmit spectrum shall not exceed the maximum of the interim transmit spectrum mask and −59 dBm/MHz at any frequency offset. FIG. 13 illustrates an example of the resulting overall spectral mask when the −40 dBr spectrum level is above −59 dBm/MHz.

FIG. 14 illustrates an example of preamble puncture mask for preamble puncturing at an edge of a FD-A-PPDU according to an embodiment of the present disclosure. FIG. 14 illustrates that, according to some embodiments of the present disclosure, if preamble puncturing is applied for FD-A-PPDU comprising one or more HE PPDUs and one or more EHT PPDUs, the spectral mask for FD-A-PPDU is subject to the interim mask for FD-A-PPDU and additional mask restrictions on punctured subchannel(s) in the FD-A-PPDU. In some embodiments, the additional mask restrictions on punctured subchannel(s) for FD-A-PPDU are the same as those for EHT PPDU that has the same BW as the FD-A-PPDU. In other words, according to the embodiments, if preamble puncturing is applied for 160 MHz FD-A-PPDU, the spectral mask for 160 MHz FD-A-PPDU is subject to the interim mask for 160 MHz FD-A-PPDU defined in FIG. 12 and the same additional mask restrictions on punctured subchannel(s) as EHT PPDU. If preamble puncturing is applied for 320 MHz FD-A-PPDU, the spectral mask for 320 MHz FD-A-PPDU is subject to the interim mask for 320 MHz FD-A-PPDU defined in FIG. 13 and the same additional mask restrictions on punctured subchannel(s) as EHT PPDU.

In more details, for preamble puncturing in FD-A-PPDU, a signal leakage from occupied subchannels to the punctured subchannels shall follow the restrictions as described below:

Case 1): When the lowest and/or the highest subchannel(s) is/are punctured in a FD-A-PPDU, the subchannel edge mask as in FIG. 14 shall be applied at the lower edge of the lowest occupied subchannel and at the higher edge of the highest occupied subchannel where M is the separation in MHz between the lower edge of the lowest occupied subchannel and the higher edge of the highest occupied subchannel in the FD-A-PPDU.

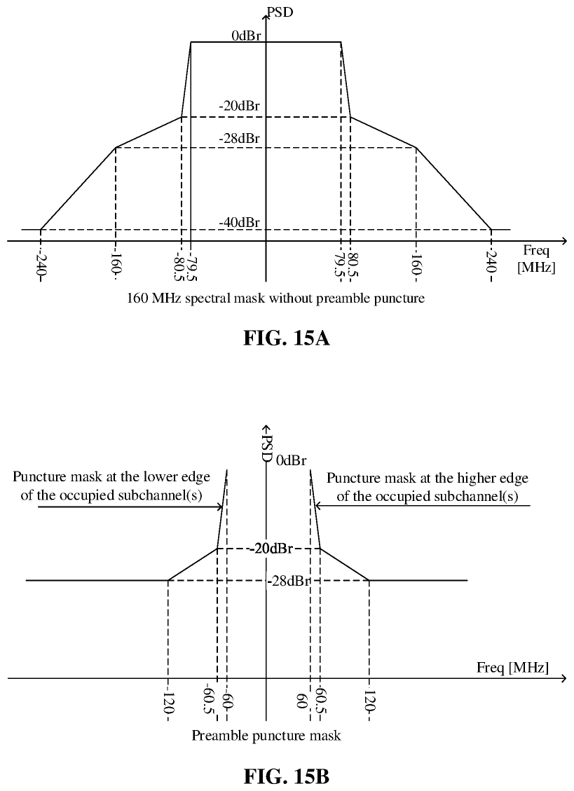

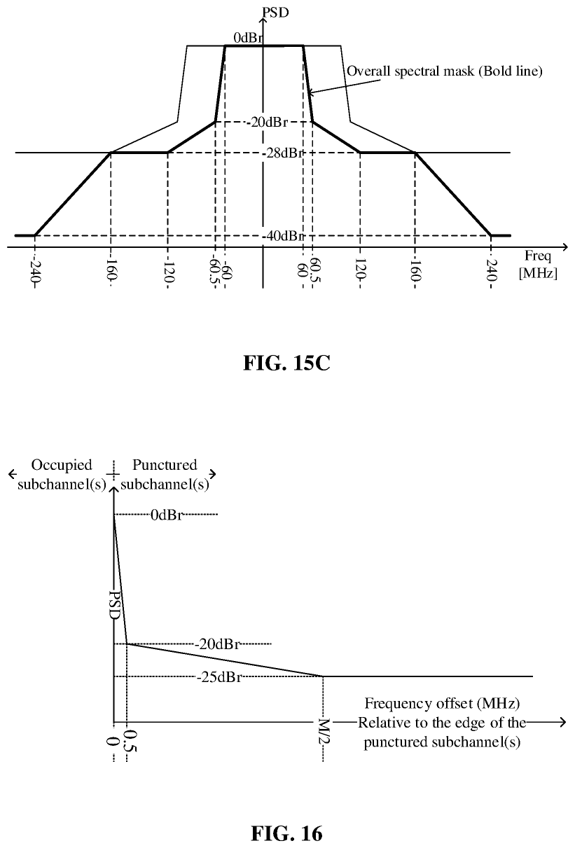

In this case, the overall spectral mask is constructed in the following manner. First, the interim spectral mask is applied according to the FD-A-PPDU's BW. Second, the preamble puncture mask in FIG. 14 is applied on the lower edge and higher edge of the occupied subchannel(s). Then for each frequency where the interim spectral mask has a value of 0 dBr but the preamble puncture mask does not have a value (in the subchannels where preamble puncture is not applied), 0 dBr shall be taken as the overall spectral mask value. For the other frequency where both the interim spectral mask and the preamble puncture mask have values greater than or equal to −40 dBr, the lower value shall be taken as the overall spectral mask value. FIG. 15A, FIG. 15B, and FIG. 15C illustrate an example for the construction of the overall spectral mask for 160 MHz FD-A-PPDU with the lowest 20 MHz subchannel and the highest 20 MHz subchannel punctured.

Case 2): When two or more contiguous 20 MHz subchannels are punctured in a FD-A-PPDU, the subchannel edge mask as in FIG. 16 shall be applied at the lower edge of the lowest punctured subchannel(s) and at the higher edge of the highest punctured subchannel(s) where M is the contiguous occupied BW in MHz adjacent to the punctured subchannel(s). Depending on the contiguous occupied BW adjacent to the lower edge of the punctured subchannel(s) and the contiguous occupied BW adjacent to the higher edge of the punctured subchannel(s), the mask applied at the lower edge and the mask applied at the higher edge of the punctured subchannel can have different value of M.

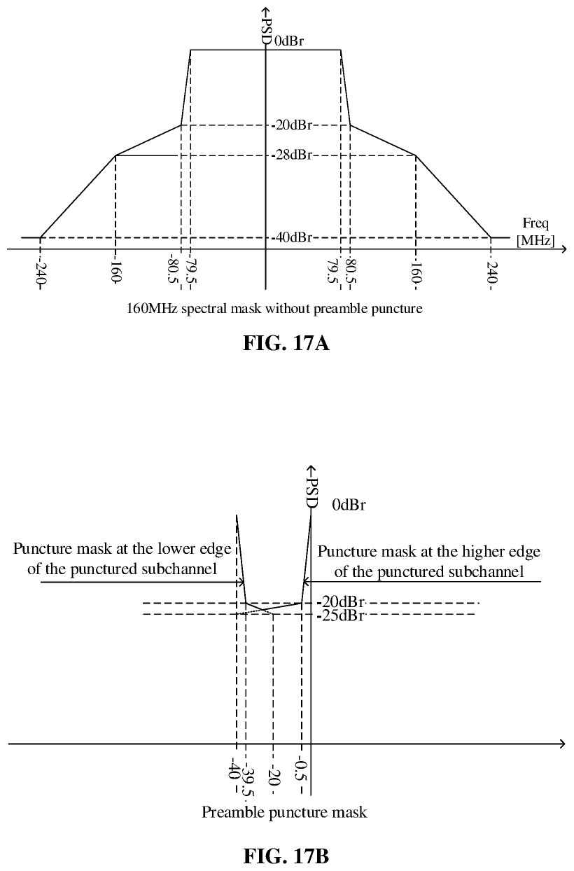

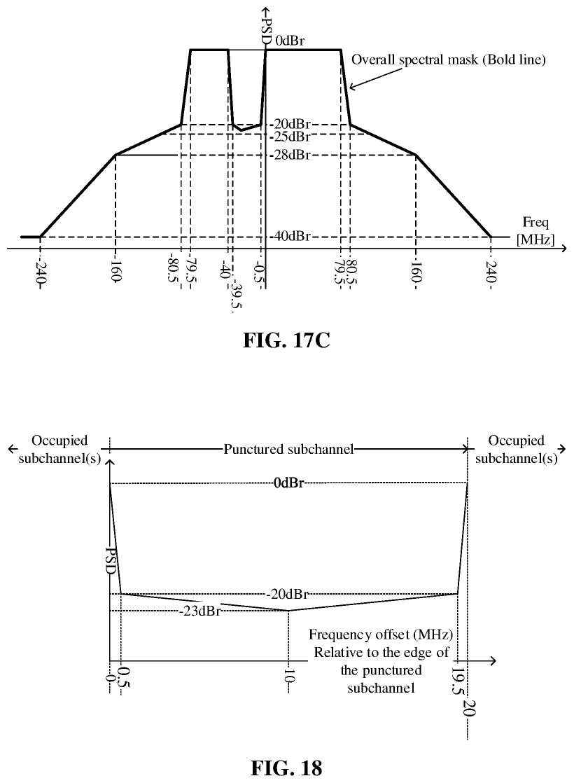

In this case, the overall spectral mask is constructed in the following manner. First, the interim spectral mask is applied according to the FD-A-PPDU's BW. Second, the preamble puncture mask in FIG. 16 is applied on both the lower edge and higher edge of the punctured subchannel(s). Note that for each frequency at which both the lower edge puncture mask and higher edge puncture mask have value greater than −25 dBr and less than −20 dBr, the larger value of the two masks shall be taken as the preamble puncture mask. Then for each frequency where the interim spectral mask has a value but the preamble puncture mask does not have a value, the value of the interim spectral mask shall be taken as the overall spectral mask value. For the other frequency where both the interim spectral mask and the preamble puncture mask have values greater than or equal to −25 dBr, the lower value shall be taken as the overall spectral mask value. FIG. 17A, FIG. 17B, and FIG. 17C illustrate an example for the construction of the overall spectral mask for 160 MHz FD-A-PPDU with the 2nd lowest 40 MHz subchannel punctured.

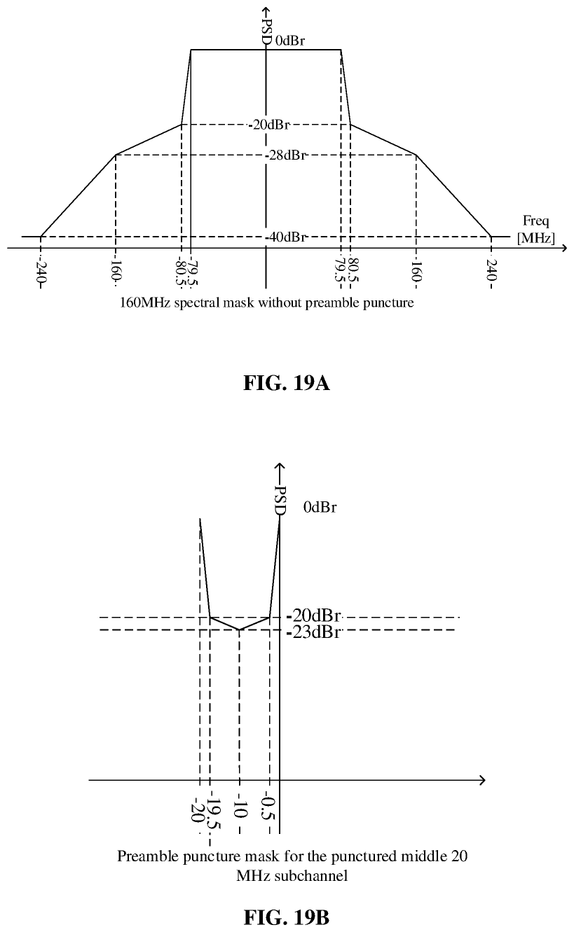

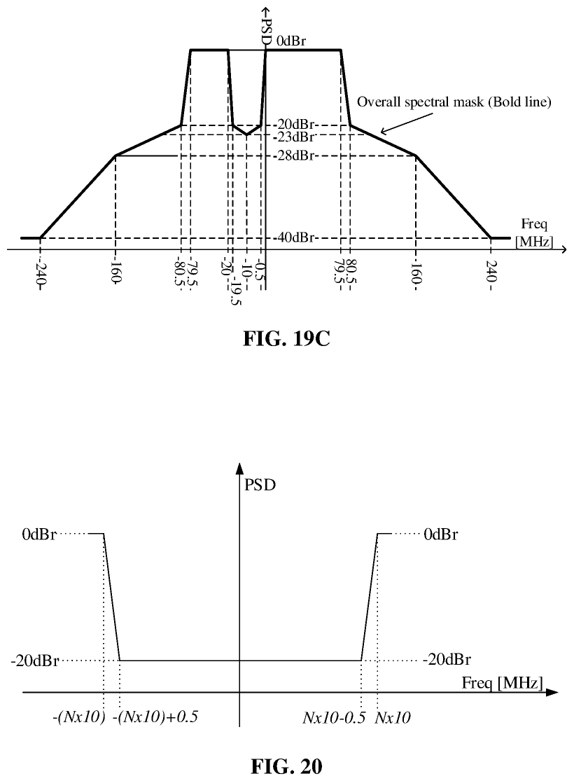

Case 3): When the punctured subchannel is equal to 20 MHz and the punctured 20 MHz subchannel is not at the edge of the FD-A-PPDU, the mask in FIG. 18 shall be applied at the punctured 20 MHz subchannel. FIG. 18 illustrates an example of preamble puncture mask for preamble puncturing in a middle of a FD-A-PPDU when a BW of a punctured subchannel is equal to 20 MHz according to an embodiment of the present disclosure. In this case, the overall spectral mask is constructed in the following manner. First, the interim spectral mask is applied according to the FD-A-PPDU's BW. Second, the preamble puncture mask in FIG. 18 is applied on the punctured 20 MHz subchannel. Then for each frequency where the interim spectral mask has a value but the preamble puncture mask does not have a value, the value of the interim spectral mask shall be taken as the overall spectral mask value. For the other frequency where both the interim spectral mask and the preamble puncture mask have values greater than or equal to −23 dBr, the lower value shall be taken as the overall spectral mask value. FIG. 19A, FIG. 19B, and FIG. 19C illustrate an example for the construction of the overall spectral mask for 160 MHz FD-A-PPDU with a fourth lowest 20 MHz subchannel punctured according to an embodiment of the present disclosure.

According to some embodiments of the present disclosure, the additional mask restrictions on punctured subchannel(s) for FD-A-PPDU may be the same as or different from those for EHT PPDU depending on the location and/or size of punctured subchannel(s) in the FD-A-PPDU.

According to some embodiments, if the punctured subchannel(s) are within the BW allocated to the one or more EHT PPDUs in the FD-A-PPDU or if the punctured subchannel(s) are an 80 MHz channel punctured from 320 MHz FD-A-PPDU as illustrates in FIGS. 11A, 11B and 11C, the additional mask restrictions on punctured subchannel(s) for FD-A-PPDU are the same as those for EHT PPDU as illustrated in FIG. 14, FIG. 16, and FIG. 18. If the punctured subchannels are within the BW allocated to the one or more HE PPDUs in the FD-A-PPDU, the additional mask restrictions on punctured subchannel(s) for FD-A-PPDU are different from those for EHT PPDU. In this case, the additional mask restrictions on punctured subchannel(s) for FD-A-PPDU are the same as those for HE PPDU. In more detail, for preamble puncture, the signal leakage to the preamble punctured channel from the occupied subchannels shall be less than or equal to −20 dBr (dB relative to the maximum spectral density of the signal) starting 0.5 MHz from the boundary of the preamble punctured channel. FIG. 20 illustrates an example of transmit spectral mask for N×20 MHz preamble punctured channel with transmissions on both upper and lower subchannels where N is a number of 20 MHz punctured subchannels within a BW allocated to one or more HE PPDUs in a FD-A-PPDU according to an embodiment of the present disclosure.

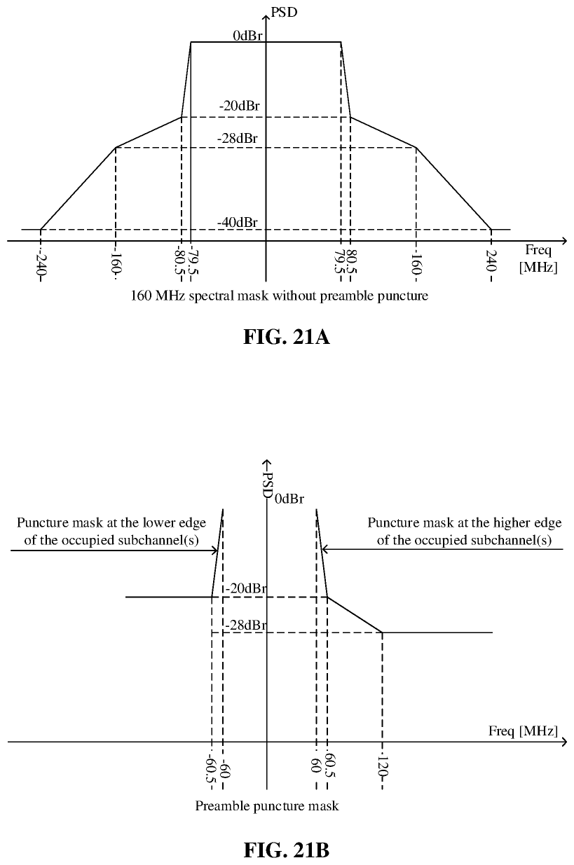

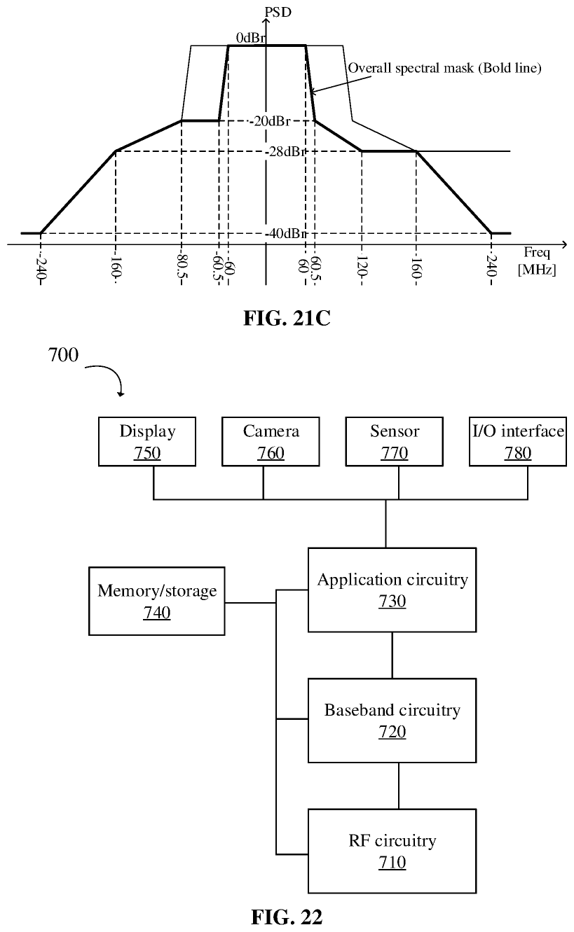

FIG. 21A, FIG. 21B, and FIG. 21C illustrate an example of construction of an overall spectral mask for 160 MHz FD-A-PPDU with the lowest 20 MHz subchannel punctured from 80 MHz HE PPDU and the highest 20 MHz subchannel punctured from 80 MHz EHT PPDU according to an embodiment of the present disclosure. FIG. 21A, FIG. 21B, and FIG. 21C illustrate that, in some embodiments, the overall spectral mask is constructed in the following manner. First, the interim spectral mask is applied according to the FD-A-PPDU's BW. Second, the preamble puncture mask is applied on the punctured subchannel(s) in the FD-A-PPDU which are subject to the additional mask restrictions on punctured subchannel(s) for HE PPDU; and the preamble puncture mask is applied on the punctured subchannel(s) which are subject to the additional mask restrictions on punctured subchannel(s) for EHT PPDU.

According to some embodiments of the present disclosure, an appropriate spectral mask which is applied to FD-A-PPDU comprising one or more HE PPDUs or one or more EHT PPDUs is able to reduce adjacent-channel interference by limiting excessive radiation at frequencies beyond the necessary BW.

Post-EHT WLAN will be the next-generation WLAN immediately after EHT WLAN. According to the present disclosure, HE STAs, EHT STAs and post-EHT STAs may coexist in a post-EHT BSS in future. A spectral mask can be applied to a FD-A-PPDU comprising one or more HE PPDUs, one or more EHT PPDUs and one or more post-EHT PPDUs in a similar manner to a FD-A-PPDU comprising one or more HE PPDUs and one or more EHT PPDUs.

In summary, if no preamble puncturing is applied for FD-A-PPDU comprising one or more HE PPDUs and one or more EHT PPDUs, how an interim transmit spectral mask is applied to the FD-A-PPDU depends on the FD-A-PPDU's BW, regardless of respective BW of the one or more HE PPDUs and the one or more EHT PPDUs in the FD-A-PPDU. An interim transmit spectral mask for EHT PPDU is reused for FD-A-PPDU that has the same BW as the EHT PPDU. If preamble puncturing is applied for FD-A-PPDU comprising one or more HE PPDUs and one or more EHT PPDUs, a spectral mask for the FD-A-PPDU is subject to the interim mask for the FD-A-PPDU and additional mask restrictions on punctured subchannel(s) in the FD-A-PPDU. The additional mask restrictions on punctured subchannels(s) for FD-A-PPDU are the same as those for EHT PPDU. Alternatively, the additional mask restrictions on punctured subchannel(s) for FD-A-PPDU may be the same as or different from those for EHT PPDU, depending on the location and/or size of punctured subchannel(s) in the FD-A-PPDU. If the punctured subchannel(s) are within the BW allocated to the one or more EHT PPDUs in the FD-A-PPDU or the punctured subchannels(s) are an 80 MHz channel punctured from 320 MHz FD-A-PPDU, the additional mask restrictions on punctured subchannel(s) for FD-A-PPDU are the same as those for EHT PPDU. If the punctured subchannels are within the BW allocated to the one or more HE PPDUs in the FD-A-PPDU, the additional mask restrictions on punctured subchannel(s) for FD-A-PPDU are different from those for EHT PPDU. In this case, the additional mask restrictions on the punctured subchannel(s) for FD-A-PPDU are the same as those for HE PPDU.

Further, for downlink FD-A-PPDU transmission, the AP generates the FD-A-PPDU, and the AP can apply the spectral mask to the FD-A-PPDU. Therefore, the above-mentioned embodiments of the present disclosure are suitable for downlink applications. On the other hand, for uplink TB FD-A-PPDU transmission, the STA only generates a HE TB PPDU or an EHT TB PPDU in the FD-A-PPDU, and the STA cannot apply the spectral mask to the whole TB FD-A-PPDU. Therefore, uplink applications can use conventional methods.

Commercial interests for some embodiments are as follows. 1. Solving issues in the prior art. 2. Applying an appropriate spectral mask to an A-PPDU comprising one or more HE PPDUs and/or one or more EHT PPDUs. 3. Mitigating interference. 4. Reducing adjacent-channel interference by limiting excessive radiation at frequencies beyond a necessary BW. 5. Achieving extremely high throughput. 6. Providing a good communication performance. 7. Providing a high reliability. 8. Some embodiments of the present disclosure are used by chipset vendors, communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in communication specification and/or communication standards such as IEEE specification and/or to standards create an end product. Some embodiments of the present disclosure propose technical mechanisms.

FIG. 22 is a block diagram of an example system 700 for wireless communication according to an embodiment of the present disclosure. Embodiments described herein may be implemented into the system using any suitably configured hardware and/or software. FIG. 22 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the AP or STA may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method, comprising:
configuring, by an access point (AP), an aggregated physical layer protocol data unit (A-PPDU) comprising one or more high efficiency (HE) PPDUs and/or one or more extremely high throughput (EHT) PPDUs; and determining if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

2. The wireless communication method of claim 1, wherein the A-PPDU further comprises one or more post-EHT PPDUs.

3. The wireless communication method of claim 2, wherein if no preamble puncturing is applied to the A-PPDU, the first spectral mask for the A-PPDU does not depend on a BW of the one or more post-EHT PPDUs in the A-PPDU.

4. The wireless communication method of claim 2, wherein the first spectral mask for the A-PPDU is the same as an interim spectral mask for post-EHT PPDU which has the same BW as the A-PPDU.

5. The wireless communication method of claim 2, wherein the mask restrictions on the one or more punctured subchannels in the A-PPDU are the same as mask restrictions on the one or more punctured subchannels for post-EHT PPDU.

6. The wireless communication method of claim 2, wherein the mask restrictions on the one or more punctured subchannels in the A-PPDU are different from mask restrictions on the one or more punctured subchannels for post-EHT PPDU.

7. The wireless communication method of claim 2, wherein whether the mask restrictions on the one or more punctured subchannels in the A-PPDU are the same as or different from the mask restrictions on the one or more punctured subchannels for post-EHT PPDU depends on a location and/or a size of the one or more punctured subchannels in the A-PPDU.

8. The wireless communication method of claim 5, wherein if the one or more punctured subchannels in the A-PPDU are within the BW allocated to the one or more post-EHT PPDUs in the A-PPDU, the mask restrictions on the one or more punctured subchannels in the A-PPDU are the same as the mask restrictions on the one or more punctured subchannels for post-EHT PPDU.

9. The wireless communication method of claim 5, wherein if the one or more punctured subchannels in the A-PPDU are within the BW allocated to the one or more HE PPDUs in the A-PPDU, the mask restrictions on the one or more punctured subchannels in the A-PPDU are different from the mask restrictions on the one or more punctured subchannels for post-EHT PPDU.

10. The wireless communication method of claim 6, wherein if the one or more punctured subchannels in the A-PPDU are within the BW allocated to the one or more HE PPDUs in the A-PPDU, the mask restrictions on the one or more punctured subchannels in the A-PPDU are the same as the mask restrictions on the one or more punctured subchannels for HE PPDU.

11. The wireless communication method of claim 6, wherein if the one or more punctured subchannels in the A-PPDU are within the BW allocated to the one or more EHT PPDUs in the A-PPDU, the mask restrictions on the one or more punctured subchannels in the A-PPDU are different from the mask restrictions on the one or more punctured subchannels for post-EHT PPDU.

12. The wireless communication method of claim 6, wherein if the one or more punctured subchannels in the A-PPDU are within the BW allocated to the one or more EHT PPDUs in the A-PPDU, the mask restrictions on the one or more punctured subchannels in the A-PPDU are the same as the mask restrictions on the one or more punctured subchannels for EHT PPDU.

13. The wireless communication method of claim 1, wherein the A-PPDU is operated in an extremely high throughput (EHT) wireless local area network (WLAN) or a post-EHT WLAN.

14. An access point (AP), comprising:
a memory;
a transceiver; and
a processor coupled to the memory and the transceiver;
wherein the processor is configured to:
configure an aggregated physical layer protocol data unit (A-PPDU) comprising one or more high efficiency (HE) PPDUs and/or one or more extremely high throughput (EHT) PPDUs; and
determine if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.

15. The AP of claim 14, wherein the A-PPDU further comprises one or more post-EHT PPDUs.

16. The AP of claim 15, wherein if no preamble puncturing is applied to the A-PPDU, the first spectral mask for the A-PPDU does not depend on a BW of the one or more post-EHT PPDUs in the A-PPDU.

17. The AP of claim 15, wherein the first spectral mask for the A-PPDU is the same as an interim spectral mask for post-EHT PPDU which has the same BW as the A-PPDU.

18. The AP of claim 15, wherein the mask restrictions on the one or more punctured subchannels in the A-PPDU are the same as mask restrictions on the one or more punctured subchannels for post-EHT PPDU.

19. The AP of claim 15, wherein the mask restrictions on the one or more punctured subchannels in the A-PPDU are different from mask restrictions on the one or more punctured subchannels for post-EHT PPDU.

20. A computer readable storage medium, in which a computer program is stored, wherein the computer program causes a computer to execute a wireless communication method, comprising:
configuring an aggregated physical layer protocol data unit (A-PPDU) comprising one or more high efficiency (HE) PPDUs and/or one or more extremely high throughput (EHT) PPDUs; and determining if no preamble puncturing is applied to the A-PPDU, a first spectral mask for the A-PPDU depends on a bandwidth (BW) of the A-PPDU and/or if a preamble puncturing is applied to the A-PPDU, a second spectral mask for the A-PPDU is subject to the first spectral mask for the A-PPDU and/or mask restrictions on one or more punctured subchannels in the A-PPDU.
